(19) United States
(12) Patent Application Publication
(10) Pub. No.: US 2009/0112541 A1
(43) Pub. Date: Apr. 30, 2009

(54) VIRTUAL REALITY TOOLS FOR DEVELOPMENT OF INFECTION CONTROL SOLUTIONS

(76) Inventors: Joel Anderson, Appleton, WI (US); Daniel Bowman, Seattle, WA (US); Valerie Cansler, Roswell, GA (US); Sudhanshu Gakhar, Neenah, WI (US); William Lynch, Greenville, WI (US); Erica Phillips, Woodstock, GA (US); Sridhar Ranganathan, Suwanee, GA (US); Richard Timmers, Bear, DE (US)

Correspondence Address: Christopher M. Goff (27839);ARMSTRONG TEASDALE LLP, ONE METROPOLITAN SQUARE, SUITE 2600, ST. LOUIS, MO, 63102, US

(21) Appl. No.: 11/925,694

(22) Filed: Oct. 26, 2007

(51) Int. Cl. G06G 7/48

(52) U.S. Cl. 703/11

(57) ABSTRACT

Embodiments of the invention provide virtual reality tools used to develop improved infection control solutions. The virtual reality tools may be applied to a variety of health care environments to develop improved infection control solutions, including improved training systems for modifying human behavior regarding hand washing (or other infection control behaviors), improved systems for evaluating the effectiveness of a proposed infection control solution, and for a producer/seller of anti-microbial products to demonstrate the superiority of one product over another or the superiority of one proposed solution over another.

### BACKGROUND OF THE INVENTION

1. Field of the Invention

Embodiments of the present invention generally relate to virtual reality simulations. More particularly, embodiments of the invention relate to virtual reality tools used to develop improved infection control solutions.

2. Description of the Related Art

Pathogens are pervasive. Although generally undetectable by the naked eye, human-beings are constantly exposed to a variety of disease-causing agents, including many forms of viruses, bacteria, and fungi. Further, as humans interact with the environment, they inevitably transmit pathogens from one location to another. A principal defense against disease causing agents, and against disease transmission, is to take measures to minimize their presence in any given environment in general, and in health-care environments in particular. Frequently, individual hand-washing may play a central role in an infection control solution. For example, a hospital operating room may employ a complex and interrelated set of procedures related to hand washing to maintain a sterile environment. Similarly, other areas of a hospital (or other health care facility) may employ various protocols to maintain a clean environment. These same issues arise in schools, clinics, day-care facilities, and really, everywhere.

The effectiveness of a given infection control protocol depends in part on how faithfully it is followed by the relevant individuals. Incentives or disincentives explicit (or implicit) in a given protocol may greatly influence individual behavior. However, as omnipresent as pathogens are, they are also invisible to the naked eye. Thus, it is often difficult to understand, analyze, interpret, or even identify how pathogens are being transmitted from one location to another in a given environment, or how individual behavior and/or the effects of incentives or disincentives contribute (or detract) from an effective solution. Thus, people often have a very difficult time developing improved infection control solutions.

### SUMMARY OF THE INVENTION

Embodiments of the invention provide virtual reality tools used to develop improved infection control solutions. The virtual reality tools may be applied to a variety of health care environments to develop improved infection control solutions, including improved training systems for modifying human behavior regarding hand washing (or other infection control behaviors), improved systems for evaluating the effectiveness of a proposed infection control solution, and for a producer/seller of anti-microbial products to demonstrate the superiority of one product over another or the superiority of one proposed solution over another.

One embodiment of the invention provides a method of generating a virtual reality simulation. The method may generally include retrieving a set of simulation data describing interactions of one or more participants with a physical environment and a disease transmission model describing how a pathogen spreads through an environment. The method may also include applying the disease transmission model to the simulation data to predict transmission of the pathogen through the physical environment, based on the simulation data, generating a virtual reality simulation depicting the predicted transmission of the pathogen through the physical environment, and presenting the virtual reality simulation to an individual on a virtual reality display platform.

In a particular embodiment, the virtual reality simulation provides the individual with a visual indication of the predicted transmission of the pathogen through the physical environment. For example, the visual indication may include variations in color and intensity used to indicate a predicted presence and a microbial load of the pathogen on a surface of the physical environment.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating components of a computing environment and virtual reality system for the development of improved infection control solutions, according to one embodiment of the invention.

FIG. 2 is a conceptual diagram further illustrating components of the virtual reality system first shown in FIG. 1, according to one embodiment of the invention.

FIG. 3 is a flow chart illustrating a method for developing improved infection control solutions, according to one embodiment of the invention.

FIG. 4 is a flow chart illustrating a method for modifying a virtual reality simulation to evaluate a given infection control solution, according to one embodiment of the invention.

FIGS. 5A-5B provide a conceptual illustration of elements of a virtual reality simulation used to develop improved infection control solutions, according to one embodiment of the invention.

### DETAILED DESCRIPTION

Embodiments of the invention provide virtual reality tools used to develop improved infection control solutions. The virtual reality tools may be applied to a variety of health care environments to develop improved infection control solutions, including improved training systems for modifying human behavior regarding hand washing (or other infection control behaviors), improved systems for evaluating the effectiveness of a proposed infection control solution, and for a producer/seller of anti-microbial products to demonstrate the superiority of one product over another or the superiority of one proposed solution over another.

In one embodiment, a virtual reality system for dealing with infection control may be used to generate a virtual reality simulation that visually represents actual behavioral data relevant to infection control, coupled with a disease transmission model to explore the impact of observed behaviors and proposed alternatives to existing systems or practices. The virtual reality systems described herein may be used, among other things, as a training tool to encourage behavioral change, as a compliance tool to assist a health care facility in improving compliance with best practices (as well as to document efforts to reduce infection), as a sales tool to show the benefits of improved products for infection control, and as a development tool for exploring alternatives and identifying key opportunity areas in infection control.

In one embodiment, virtual reality tools may be combined with actual on-site data acquired over a period of time to model the potential transmission of pathogens within a given environment. As described in greater detail herein, embodiments of the invention may include a data acquisition system for monitoring the location of individuals in a health care setting, their hand washing behaviors, and their contact with various surfaces, including contact with other individuals (e.g., a patient). A virtual reality system may be configured to visually represent the observed environment and the participants' behaviors and interaction with the observed environment for a given period of time. A disease transmission model may be used to predict how a pathogen may spread through an environment, e.g., from a person's hands to other surfaces or from one object to another. The transmission of the normally invisible pathogens may be represented visually in a manner that is integrated with the virtual reality simulation. Further, the virtual reality tool may be configured to provide alternative scenarios for a virtually reality simulation to help a health care partner recognize the benefits of a proposed change in products, procedures, layouts, dispensing systems, etc.

Additionally, embodiments of the invention are described herein using a hospital hand washing station to illustrate an example of a virtual reality simulation. However, one of ordinary skill in the art will recognize that the virtual reality tool disclosed herein may be adapted for use with a variety of environments where individual interaction with the environment may lead to disease or pathogen transmission.

Further, the following description references embodiments of the invention. However, it should be understood that the invention is not limited to any specifically described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable media. Illustrative computer-readable media include, but are not limited to: (i) non-writable storage media on which information is permanently stored (e.g., read-only memory devices within a computer such as CD-ROM or DVD-ROM disks readable by a CD-ROM or DVD-ROM drive); (ii) writable storage media on which alterable information is stored (e.g., floppy disks within a diskette drive, hard-disk drives, or flash memory devices). Other media include communications media through which information is conveyed to a computer, such as through a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

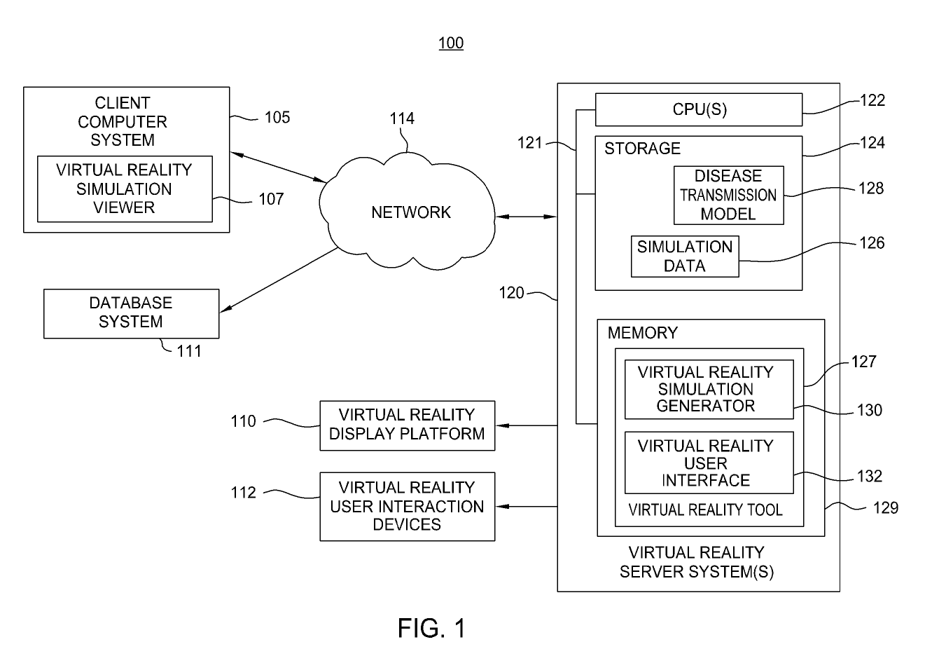

FIG. 1 is a block diagram illustrating components of a computing environment and virtual reality system for the development of improved infection control solutions, according to one embodiment of the invention. As shown, computing environment 100 includes a client computer system 105 and a database system 111 in communication with a virtual reality server system 120 over a network 114. The computer systems 105, 111, and 120 illustrated in environment 100 are included to be representative of existing computer systems, e.g., desktop computers, server computers, laptop computers, tablet computers and the like. However, embodiments of the invention are not limited to any particular computing system, application, device, or network architecture and instead, may be adapted to take advantage of new computing systems and platforms as they become available. Additionally, those skilled in the art will recognize that the illustrations of computer systems 105, 111, and 120 are simplified to highlight aspects of the present invention and that computing systems and networks typically include a variety of components not shown in FIG. 1.

As shown, server system 120 includes one or more CPUs 122, storage 124, and memory 129 connected by a bus 121. CPU 122 is a programmable logic device that executes the instructions, logic and mathematical processing as necessary to execute user applications (e.g., a virtual reality tool 127). Storage 124 stores application programs and data for use by server system 120. Common storage devices 124 include hard-disk drives, flash memory devices, optical media and the like. Client system 105 and database system 111 may include similar components (not shown). Client system 105 may be used to execute a virtual reality simulation viewer 107. Simulation viewer 107 may present a user with the content of a virtual reality simulation.

Network 114 represents any kind of data communications network, including both wired and wireless networks. Accordingly, network 114 is representative of both local and wide area networks, including the internet.

In one embodiment, server system 120 includes a virtual reality tool 127. Illustratively, virtual reality tool 127 includes a virtual reality simulation generator 130 and a user interface 132. User interface 132 may allow users to interact with and control the actions of virtual reality tool 127. Virtual reality tool 127 may provide a software application configured to generate a virtual reality simulation from simulation data 126 and a disease transmission model 128. In one embodiment, simulation data 126 is collected by monitoring a group of simulation participants as they interact with a particular environment. For example, a week-long data acquisition trial could be conducted for an operating room, including hand washing stations. Regarding data acquisition, several methods may be used, e.g., data regarding human motion may be tracked using badges that contain RFID (radio frequency ID) tags whose location can be precisely determined by triangulating data from multiple RFID readers.

As another example, participant locations and actions may be tracked using video monitoring tools coupled with pattern recognition/image recognition software tools to identify individuals and their actions, including hand washing, duration of hand washing, what objects an individual touches, etc. Another technique includes manual data entry of contact events based on a review of captured video footage. In such a case, a database on system 111 may be configured to store event information (e.g., time, duration, extent of contact, etc.) for each participant in the study. These approaches are described in more detail below. In any event, however acquired, data from database system 111 may be transmitted to server system 120 and stored as simulation data 126.

Data from database system 111 may generally represent individual motion, activities, and contact events that may be included in a virtual reality simulation of this activity. For example, a virtual reality display platform 110 and/or virtual reality user interaction devices 112 may allow users to experience rapid “fly-through” motions through the simulated environment or to experience the simulation from the perspective of a given participant. The data may be integrated into a virtual reality simulation that represents the physical space, coupled with avatars (if desired) representing study participants as they move and interact with objects. Human representation is not necessary, however. For example, a week's worth of participants contact data could be portrayed rapidly, and regions of frequent contact can be highlighted with brightness, color, labels, etc, in the virtual reality simulation.

Disease transmission model 128 may be used to predict or simulate the transmission of pathogens through the simulated environment. For example, participants observed in the study may be assumed to have a certain microbial loading of a given pathogen on their hands. The load may include ordinary bacterial levels, or arbitrary loadings of ordinary bacteria, antibiotic resistant bacteria, etc. This initial loading can then be an input to disease transmission model 128, which in turn tracks how the pathogen may be spread through the environment as the result of subsequent interactions with surfaces and participants, e.g., based on simulation data 126. The disease transmission model 128 may consider hand washing data for any person being tracked, and data related to duration of washing or other actions may be used to predict changes to the microbial load of the pathogen on the participants' hands after washing. Disease transmission model 128 may be configured to predict a microbial load left on a surface after contact or the load that is picked up from a contaminated surface after contact. The model can also provide for separate consideration of background bacteria or the interaction of multiple pathogens.

In one embodiment, disease transmission model 128 may be based upon studies of microbial transmission and may be configured to account for surface material, estimated extent and duration of contact, microbial type, and other factors. For example, disease transmission model 128 may be based on transmission studies using “glow germ” strains of bacteria that produce fluorescent proteins for easy visualization in ultraviolet light. The location of such bacteria after they have been spread by a series of contact events can be readily visualized using an UV light.

In one embodiment, disease transmission model 128 and simulation data 126 may be used by virtual reality simulation generator 130 to generate a virtual reality simulation of a health care environment. Of course, other environments may be depicted in a virtual reality simulation as well. In any case, the resulting virtual reality simulation may model microbial levels as they are predicted to have been spread from person-to-person, person-to-surfaces, etc based on the actions of the participants and disease transmission model 128. Further, virtual reality simulation may represent microbial loadings in any way to convey information about the presence of the microbes and their characteristics. For example, the virtual reality simulation may depict a physical environment and represent study participants as avatars moving through the simulated environment. Microbial loads may be presented as glowing regions (e.g., green regions for bacteria considered benign and red regions for bacteria considered potentially harmful). The microbial load may be represented by varying the size and/or the intensity of the glowing region. As an avatar touches a contaminated surface some of the glowing region “transfers” to the avatar, and subsequently, when the avatar touches other surfaces (or individuals) some of the glowing region may continue to “transfer” to each surface the avatar comes in contact with. The disease transmission model 128 may account for anticipated bacterial growth, as well as for the effectiveness of anti-microbial agents, surfaces, or hand washing activity. Using this information, the virtual reality simulation may also represent the amount of microbes ultimately transferred to a patient by contact with people or with contaminated objects, and can display information about the apparent threat level represented by the transferred microbial loadings.

Thus, virtual reality tool 127, simulation data 126 and disease transmission model 128 may, collectively, generate and display relevant parties with a virtual reality simulation that allows problematic behaviors and systems to be identified rapidly, and allow improved training or system modifications to be made to reduce the risk of infection. The virtual reality simulation may be presented to the appropriate individual on a computer monitor or TV screen, hemispherical virtual reality pods, systems of multiple display panels, or in more sophisticated virtual reality environments such as a virtual reality cave. Alternatively, display of 3-D results may be achieved using virtual reality headsets or other known devices. Sound, aroma, and tactile feedback may also be provided to enhance the experience or to communicate additional information regarding, for example, health threats or unacceptable behaviors.

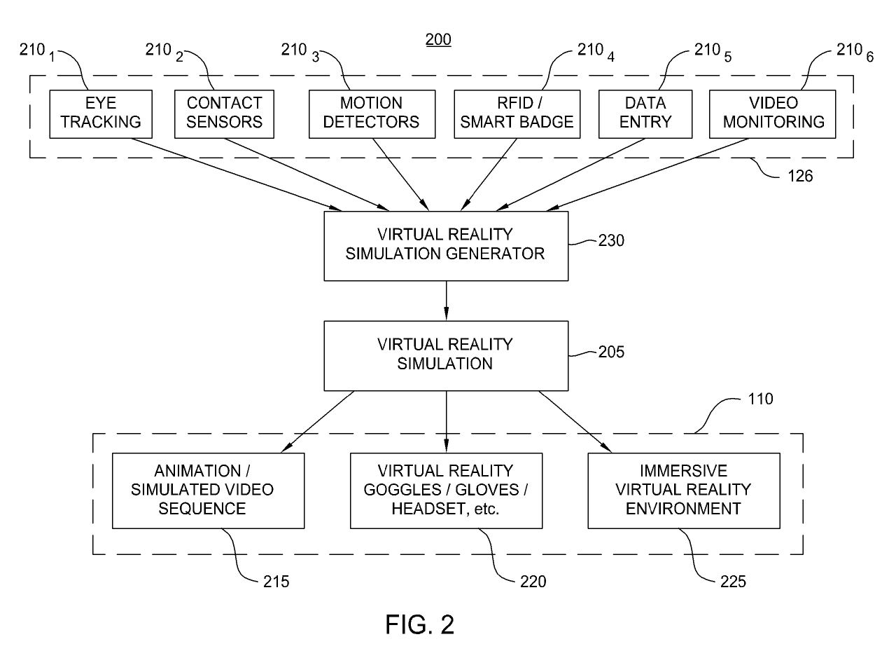

FIG. 2 is a conceptual illustration of components of the virtual reality system first shown in FIG. 1, according to one embodiment of the invention. As shown, simulation data 126 may be collected using a variety of data acquisition systems 210. Each data acquisition system 210 may be used to obtain simulation data 126 related to the actions of health care staff. In one embodiment, data acquisition systems 210 may be used to construct an instrumented hand washing station configured with electronic sensors, cameras, etc., to track hand washing events and information about each event such as duration, amount of alcohol gel (or other antimicrobials) applied, etc.

Illustratively, data acquisition systems 210 includes video systems 210₆ to monitor, track, and recognize activities such as opening doors, touching patients or objects in a room, hand washing activities, etc. Smart badge systems 210₄ may include RFID or other wireless means to identify the location of health care staff and their proximity to items of interest such as hand washing stations. Wrist bands with RFID tags may also be used on patients or study participants. Motion detection systems 210₃ may include light fields, ultrasonic motion detectors, and other motion or object detection systems. Patient contact sensors 210₂ (e.g., an inductive coil device) may be used to detect changes in electrical properties when another person establishes physical contact with the skin of the patient. Data entry system 210₅ may include human monitors, remote or physically present, may observe and record events of interest. Eye tracking systems 210₁ may be used to monitor and record what a given individual views at any given point in time. For example, the instrumented hand washing station may include eye tracking systems 210₁ used to identify what elements of the station may attract the attention of a person while that person interacts with the hand washing station. Of course, other systems may be used. For example, a wireless system designed to track hand washing is disclosed in U.S. Pat. No. 6,392,546, “Hand Washing Compliance Measurement and Recording System,” issued May 21, 2002 to Smith. And an example of an ultrasonic technique for determining hand washing events is disclosed in U.S. Pat. No. 5,573,041, “Dispenser Control with Ultrasonic Position Detection,” issued Nov. 12, 2002 to Skell.

As described above, each of the data acquisition systems 210 may be used by virtual reality simulation generator 130 to generate virtual reality simulation 205. In one embodiment, virtual reality simulation 205 may present a simulation of a given physical environment that includes all the events and actions of the simulation participants, as recorded by the data acquisition systems 210. The resulting virtual reality simulation 205 may be presented on a virtual reality display platform. Illustratively, FIG. 2 shows a variety of virtual reality display platforms 110. As shown, virtual reality display platform 110 includes an animation or simulated video sequence 215 (viewed using virtual reality simulation viewer 107), virtual reality goggles, gloves and/or headset, etc. 220, and an immersive virtual reality environment 225 (e.g., a virtual reality sphere, cave or cube). Of course, the examples shown in FIG. 2 provide examples of virtual reality display platforms 110, and embodiments of the invention may be adapted for use with these, or other virtual reality systems, whether currently known or subsequently developed.

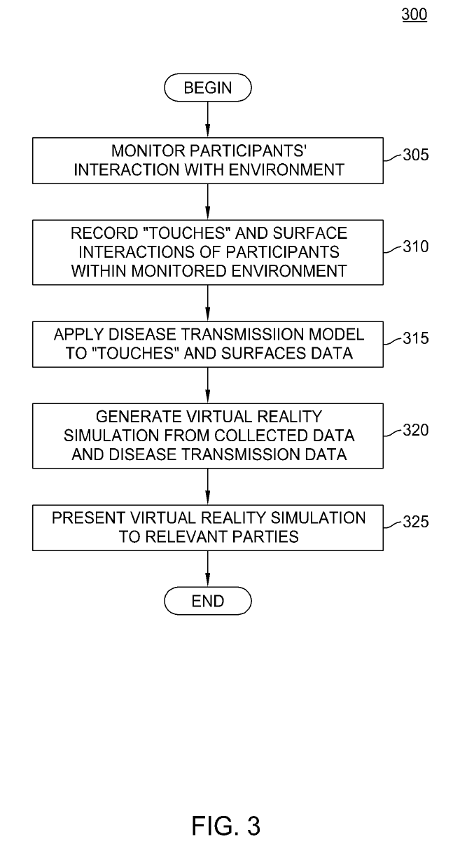

FIG. 3 is a flow chart illustrating a method 300 for developing improved infection control solutions, according to one embodiment of the invention. As shown, the method 300 begins at step 305 where a one or more data acquisition systems are used to monitor participants' interaction with a given environment. At step 310, as the participants interact with the environment, the data acquisition systems record events relevant to a given disease transmission model. As described, the tracked human interactions can include those of health care staff, patients, visitors, cleaning staff, delivery personnel, etc.

At step 315, a disease transmission model may be applied to predict how pathogens may be transmitted as a result the events recorded at step 310. As described, the disease transmission model can include the impact of actions by all such personnel (e.g., bacterial loads in a room may be shown to be reduced after cleaning activities from janitorial personnel, who may also spread some bacterial loads in the facility.

At step 320, a virtual reality simulation is generated to depict the monitored environment and the presence (or absence) of pathogens moving through the monitored environment. The virtual reality simulation may also depict the participants' interactions with the environment. For example, the virtual reality simulation may include avatars to represent the actions of each participant in the simulation. Once generated, at step 325 the virtual reality simulation may be presented to the relevant parties.

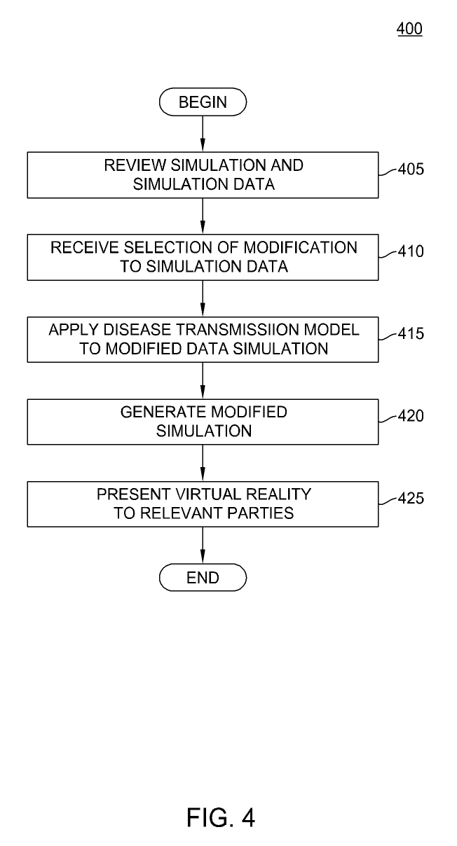

FIG. 4 is a flow chart illustrating a method 400 for modifying a virtual reality simulation to evaluate a given infection control solution, according to one embodiment of the invention. As shown, the method begins at step 405, where a reviewer may review a virtual reality simulation and the data used in generating the simulation. At step 410, a virtual reality tool may receive a selected modification to the simulation data. For example, the presence of a given participant may be removed from the simulation entirely, or certain actions of a participant may be changed. Similarly, elements of the physical environment may be added or removed. Also similarly, the pathogens represented by the disease transmission model or the initial microbial loads may be modified.

At step 415, the disease transmission model is applied to the modified simulation data, and at step 420, a virtual reality simulation is generated to depict the monitored environment and the presence (or absence) of pathogens moving through the monitored environment. The virtual reality simulation may depict also the participants' interactions with the environment. For example, the virtual reality simulation may include avatars to represent the actions of each participant in the simulation. Once generated, at step 425 the virtual reality simulation may be presented to the relevant parties.

Method 400 may be useful for developing develop improved infection control solutions, including improved training systems for modifying human behavior regarding hand washing (or other infection control behaviors), improved systems for evaluating the effectiveness of a proposed infection control solution, and for a producer/seller of anti-microbial products to demonstrate the superiority of one product over another or the superiority of one proposed solution over another.

For example, method 400 may be used to train health care staff by graphically identifying possible outcomes of actual behaviors, resulting in improved staff behavior in future cases. Simulation data collected over a given period of time may reflect the interaction of staff (and others monitored participants) with both objects and patients present in a health care setting. The simulation data may be used by a virtual reality tool to generate a virtual representation of the environment. Such a simulation may allow for a customized replay of the observed events. Avatars representing the participants may move through the system and perform actions of the staff such as opening doors, touching patients, washing hands, etc. Additionally, the simulation may be customized in a variety of ways. For example, events may be replayed at high speeds, allowing a long period of time to be simulated rapidly. Another example includes customizing a virtual reality simulation to increase (and decrease) the playback speed to traverse through the simulation between interesting events. Further, contact events (i.e., touching of objects by monitored participants) can be highlighted. For example, each area touched by a participant may be made to appear to glow in the simulation, and multiple contacts may result in a more intense visual effect or in other graphical information being presented to a simulation viewer.

Thus, the virtual reality simulation may be used to identify “hot spots” or trouble areas where pathogens may be being transmitted. For example, the health care staff could view a virtual reality replay of their own actions and understand the potential threats created by their behaviors. This could be provided as a tool for training the staff and for encouraging peer pressure among the staff for improved behavior. Further, the system can be used to demonstrate a health care facility's compliance with best practices for use in dealing with insurers or in legal challenges, wherein data about hand washing effectiveness and other best practices can be graphically portrayed.

Similarly, method 400 may be used to explore a variety of alternative scenarios for an infection control solution. For example, the data used to generate data underlying a simulation may be used to explore how changes in physical settings or in behaviors may modify the outcomes. In one scenario, disease transmission results may be used to show pathogen transmission based on a health care worker having good versus poor hand washing behavior. In another scenario, the simulation may be modified to predict the effect of eliminating a door or converting a door that people contact to open into a door that opens automatically, thereby eliminating a portion of the environment typically touched by the participants. In another version, a frequently touched surface is modified to include an antimicrobial coating or other antimicrobial efforts (e.g., periodic pulses of UV light to the surface) to reduce microbial loads, and then the disease transmission model may be used to compare the risk levels between the two or more alternate scenarios. In still another scenario, the impact of failure to wear gloves or a face masks may be simulated.

In another scenario, the virtual reality simulation may depict two related scenarios that differ in the use of a particular product, such as an improved cleaning wipe, improved protective equipment, or a device with an antimicrobial coating versus a similar device without the coating. Thus, the impact of the difference in microbial transmission based on the different equipment may then be modeled and displayed visually in the virtual reality simulation. Similarly, a modification to the layout of a room may be proposed, and the impact of the change on the order and flow of products within the modified room may be modeled by the virtual reality simulation, including the impact of disease transmission.

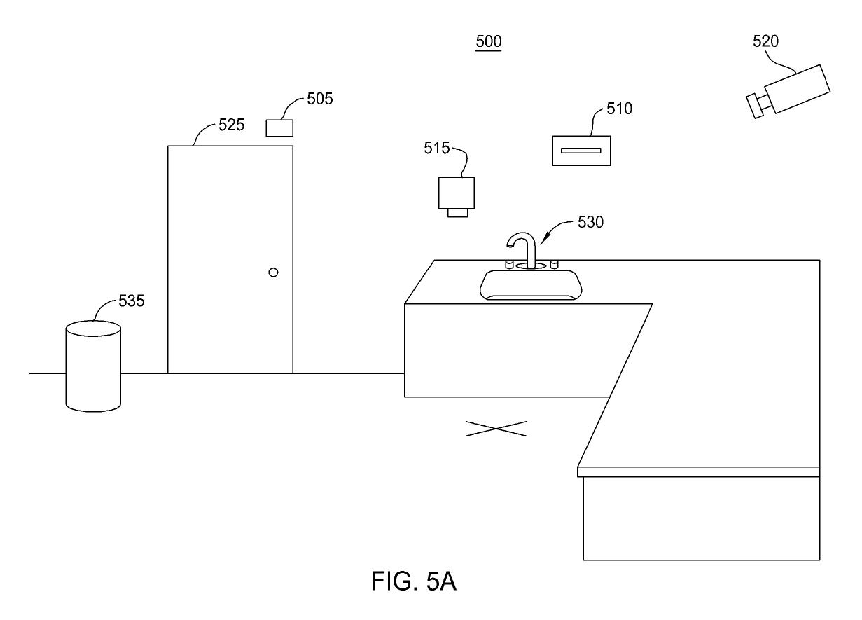

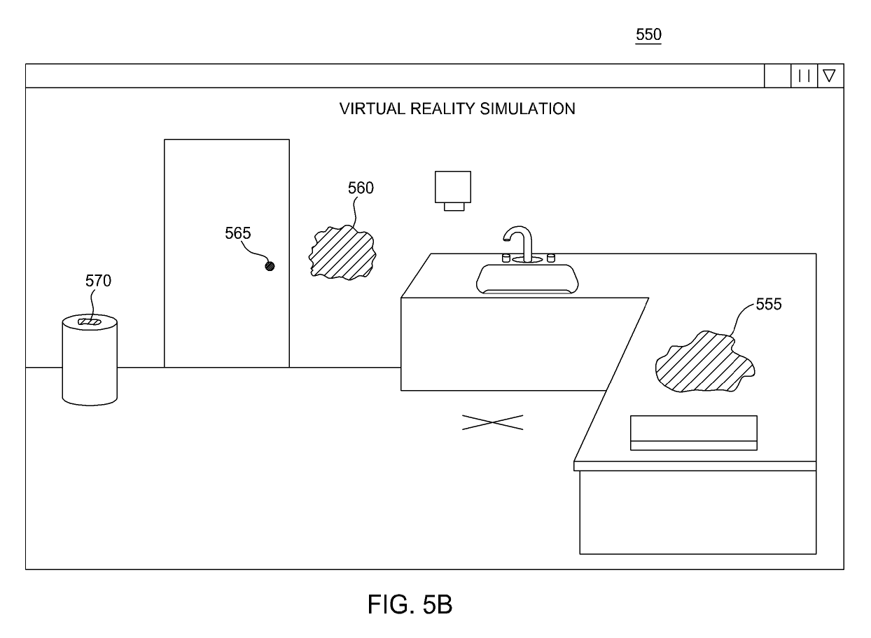

FIGS. 5A-5B provide a conceptual illustration of elements of a virtual reality simulation used to develop improved infection control solutions, according to one embodiment of the invention. First, FIG. 5A is included to represent an actual physical environment monitored by a set of data acquisition systems. In this example, assume that physical environment 500 is a hand washing station at a health-care facility. Illustratively, physical environment 500 includes a dispenser 515, an eye tracking device 510, a video camera 520, and an RFID sensor 505. As participants enter through a door 525, the RFID sensor 505 may create a record of the event in database 111. Similarly, as the user interacts with elements of the hand washing station 530 (e.g., the sink, faucet, and dispenser 515), the video camera 520 and eye tracking device 510 may record data regarding the different aspects of the participant's actions within physical environment 500. And from this information, a virtual reality simulation of physical environment 500 may be generated that includes a representation of pathogen transmission, based on a disease transmission model.

For example, FIG. 5B illustrates a simulated environment 550 generated to represent physical environment 500. Accordingly, the simulated environment 550 includes the elements of the physical environment 500. Assume that the depiction of simulated environment 550 is generated after a number of participants have interacted with the physical environment 500. Illustratively, simulated environment 550 includes regions 555, 560, 565, and 570, displaying the presence of pathogens. The presence of these pathogens may be predicted based on the interactions of the participants based on a given disease transmission model. Note, as shown in FIG. 5B, simulated environment 550 is presented statically, that is, as a single frame of animation. However, as described herein, the simulated environment 550 may be part of animated visual sequence that shows avatars representing participants interacting with the environment over time, and that also shows the presence, absence, growth, and or transmission of a pathogen, based on a given disease transmission model.

Advantageously, embodiments of the invention may be used to generate and display a variety of scenarios to explore the impact of changes in behavior, products, layouts, etc., to assist health care workers in their behaviors as well as to assist administrators in decisions regarding order and flow, products used, facility design, etc., as it relates to pathogen transmission in a given environment. Embodiments of the invention provide virtual reality tools used to develop improved infection control solutions. The virtual reality tools may be applied to a variety of health care environments to develop improved infection control solutions, including improved training systems for modifying human behavior regarding hand washing (or other infection control behaviors) and improved systems for evaluating the effectiveness of a proposed infection control solution.

Further, embodiments of the virtual reality system described herein may be used as a customer relationship management tool in which a vendor assists a health care customer by generating virtual reality simulations to demonstrate how proposed changes might reduce the risk of infection. Further, because the virtual reality simulations may provide a visual display of pathogen presence (which is otherwise invisible), intensity and transmission, embodiments of the invention may be used by such a vendor to present a compelling case for a proposed infection control solution.

While the foregoing is directed to embodiments of the present invention, other and further embodiments of the invention may be devised without departing from the basic scope thereof, and the scope thereof is determined by the claims that follow.

What is claimed is:

1. A computer-implemented method of generating a virtual reality simulation, comprising:
retrieving a set of simulation data describing interactions of one or more participants with a physical environment;
retrieving a disease transmission model describing how a pathogen spreads through an environment;
applying the disease transmission model to the set of simulation data to predict transmission of the pathogen through the physical environment, based on the set of simulation data;
generating a virtual reality simulation depicting the predicted transmission of the pathogen through the physical environment; and
presenting the virtual reality simulation to an individual on a virtual reality display platform.

2. The method of claim 1, wherein the virtual reality simulation provides the individual with a visual indication of the predicted transmission of the pathogen through the physical environment.

3. The method of claim 2, wherein the visual indication includes variations in color and intensity used to indicate a predicted presence and a microbial load of the pathogen on a surface of the physical environment.

4. The method of claim 1, further comprising:
receiving a selection of a modification to the set of simulation data;
applying the disease transmission model to the modified simulation data to predict transmission of the pathogen through the physical environment, based on the modified simulation data;
generating a second virtual reality simulation depicting the predicted transmission of the pathogen through the physical environment; and
presenting the second virtual reality simulation to an individual on a virtual reality display platform, wherein changes in predicted transmission of the pathogen through the physical environment, based on the modified simulation data are highlighted in the second virtual reality simulation.

5. The method of claim 1, wherein the set of simulation data specifies an initial microbial load of the pathogen for the physical environment, and wherein the interactions of the one or more participants with the physical environment are used by the disease transmission model to predict the spread of the pathogen through the physical environment.

6. The method of claim 1, wherein the virtual reality simulation further depicts the one or more participants interacting with the physical environment.

7. The method of claim 1, wherein the disease transmission model is based on studies of microbial transmission configured to account for surface material, estimated extent and duration of contact between a participant and a surface, contact between simulation participants, microbial type, and for the actions of the participants to reduce or eliminate the pathogen from the physical environment.

8. The method of claim 1, further comprising, recording the participants interacting with the physical environment, wherein the recorded interactions are used to generate the set of simulation data.

9. A system, comprising:
a processor;
a memory storing a virtual reality tool, wherein the virtual reality tool is configured to:
retrieve a set of simulation data describing interactions of one or more participants with a physical environment,
retrieve a disease transmission model describing how a pathogen spreads through an environment,
apply the disease transmission model to the simulation data to predict transmission of the pathogen through the physical environment, based on the simulation data, and
generate a virtual reality simulation depicting the predicted transmission of the pathogen through the physical environment; and
a virtual reality display platform configured to present the virtual reality simulation to an individual.

10. The system of claim 9, wherein the virtual reality simulation provides the individual with a visual indication of the predicted transmission of the pathogen through the physical environment.

11. The system of claim 10, wherein the visual indication includes variations in color and intensity used to indicate a predicted presence and a microbial load of the pathogen on a surface of the physical environment.

12. The system of claim 9, wherein the virtual reality tool is further configured to:
receive a selection of a modification to the set of simulation data;
apply the disease transmission model to the modified simulation data to predict transmission of the pathogen through the physical environment, based on the modified simulation data;
generate a second virtual reality simulation depicting the predicted transmission of the pathogen through the physical environment; and
present the second virtual reality simulation to an individual on a virtual reality display platform, wherein changes in predicted transmission of the pathogen through the physical environment, based on the modified simulation data are highlighted in the second virtual reality simulation.

13. The system of claim 9, wherein the set of simulation data specifies an initial microbial load of the pathogen for the physical environment, and wherein the interactions of the one or more participants with the physical environment are used by the disease transmission model to predict the spread of the pathogen through the physical environment.

14. The system of claim 9, wherein the virtual reality simulation further depicts the one or more participants interacting with the physical environment.

15. The system of claim 9, wherein the disease transmission model is based on studies of microbial transmission configured to account for surface material, estimated extent and duration of contact between a participant and a surface, contact between simulation participants, microbial type, and for the actions of the participants to reduce or eliminate the pathogen from the physical environment.

16. The system of claim 9, wherein the virtual reality display platform comprises an immersive virtual reality environment.

17. The system of claim 9, further comprising:
a data acquisition system configured to monitor the participants interacting with the physical environment to generate the set of simulation data.

18. The system of claim 17, wherein the data acquisition system includes at least on of a video recording system, a motion sensing system, an eye movement tracking system, and a data entry system.

19. A computer-implemented method for a product manufacturer to manage a relationship with a health care provider that uses one or more products manufactured by the product manufacturer, comprising:
retrieving a set of simulation data describing interactions of one or more participants with a physical environment, including at least one interaction between one of the participants and one of the one or more products;
retrieving a disease transmission model describing how a pathogen spreads through an environment;
applying the disease transmission model to the simulation data to predict transmission of the pathogen through the physical environment, based on the set of simulation data;
generating a virtual reality simulation depicting the predicted transmission of the pathogen through the physical environment; and
presenting the virtual reality simulation to a representative of the health care provider.

20. The method of claim 19, wherein the virtual reality simulation provides the individual with a visual indication of the predicted transmission of the pathogen through the physical environment.

21. The method of claim 20, wherein the visual indication includes variations in color and intensity used to indicate a predicted presence and a microbial load of the pathogen on a surface of the physical environment.

22. The method of claim 19, further comprising:
receiving a selection of a modification to the set of simulation data, wherein the modification is selected to highlight how the use of the one or more products affects the transmission of the pathogen through the physical environment;
applying the disease transmission model to the modified simulation data to predict transmission of the pathogen through the physical environment, based on the modified simulation data;
generating a second virtual reality simulation depicting the predicted transmission of the pathogen through the physical environment; and
presenting the virtual reality simulation to the representative of the health care provider, wherein changes in predicted transmission of the pathogen through the physical environment, based on the modified simulation data, are highlighted in the second virtual reality simulation.
